(19) United States
(12) Patent Application Publication
(10) Pub. No.: US 2022/0100153 A1
(43) Pub. Date: Mar. 31, 2022

(54) MODEL-FREE CONTROL OF DYNAMICAL SYSTEMS WITH DEEP RESERVOIR COMPUTING

(71) Applicants: Ohio State Innovation Foundation, Columbus, OH (US); POTOMAC RESEARCH LLC, Alexandria, VA (US)

(72) Inventors: Daniel CANADAY, Columbus, OH (US); Andrew Joseph POMERANCE, Alexandria, VA (US); Aaron Geoffrey GRIFFITH, Reynoldsburg, OH (US); Daniel GAUTHIER, Hilliard, OH (US)

(21) Appl. No.: 17/426,071

(22) PCT Filed: Jan. 28, 2020
(86) PCT No.: PCT/US2020/015350

§ 371 Date: Jul. 27, 2021

Related U.S. Application Data
(60) Provisional application No. 62/836,310, filed on Apr. 19, 2019.
(60) Provisional application No. 62/797,561, filed on Jan. 28, 2019.

(51) Int. Cl. G05B 13/02

(52) U.S. Cl. CPC G05B 13/027; G05B 13/021; G05B 13/026

(57) ABSTRACT

A technique is provided for control of a nonlinear dynamical system to an arbitrary trajectory. The technique does not require any knowledge of the dynamical system, and thus is completely model-free. When applied to a chaotic system, it is capable of stabilizing unstable periodic orbits (UPOs) and unstable steady states (USSs), controlling orbits that require non-vanishing control signal, synchronization to other chaotic systems, and so on. It is based on a type of recurrent neural network (RNN) known as a reservoir computer (RC), which, as shown, is capable of directly learning how to control an unknown system. Precise control to a desired trajectory is obtained by iteratively adding layers to the controller, forming a deep recurrent neural network.

### CROSS-REFERENCE TO RELATED APPLICATIONS

This application claims the benefit of U.S. provisional patent application No. 62/797,561, filed on Jan. 28, 2019, and entitled “MODEL-FREE CONTROL OF CHAOS WITH DEEP RESERVOIR COMPUTING,” and U.S. provisional patent application No. 62/836,310, filed on Apr. 19, 2019, and entitled “MODEL-FREE CONTROL OF DYNAMICAL SYSTEMS WITH DEEP RESERVOIR COMPUTING,” the disclosures of which are expressly incorporated herein by reference in their entirety.

### BACKGROUND

Control of nonlinear dynamical systems is a ubiquitous problem in many areas of physics and engineering.

The effects of perturbations introduced to a nonlinear dynamical system by potential control signals are difficult to predict, making the design of such control signals a difficult task.

Chaos is a phenomenon that occurs in a wide range of deterministic systems, such as laser cavities, weather systems, heart tissue, etc. The phenomenon is defined by sensitivity to initial conditions, meaning that nearby trajectories of the system state diverge exponentially over time. This divergence leads to random-like behavior that makes long-term prediction impossible. Conventional chaos-control methods require the controller to be switched on in a small neighborhood of the desired orbit. The time required to wait for this condition may be large, resulting in long control times. Further, they are not capable of controlling more general motions, such as periodic orbits not embedded in the attractor.

It is with respect to these and other considerations that the various aspects and embodiments of the present disclosure are presented.

### SUMMARY

Deep reservoir computers are a powerful tool in nonlinear control engineering, including chaos control, capable of learning a wide range of control laws for completely unknown systems. Certain aspects of the present disclosure relate to training a deep reservoir computer for precise, model-free control of a plant displaying nonlinear dynamics, and a deep reservoir computing architecture that trains higher layers by viewing the plant and previous layers as a new plant to be controlled. Systems and techniques are provided for precise, model-free control of dynamical systems with a deep reservoir computer.

Control systems, techniques, and algorithms are provided that overcome the conventional drawbacks and disadvantages, and that achieve robust control of an unknown dynamical system to an arbitrary trajectory. The systems, techniques, and algorithms are based on a type of recurrent neural network (RNN) known as a reservoir computer (RC). The network is trained to invert the dynamics of the dynamical system, thereby directly learning how to control it. The resulting controller is a fully non-linear dynamical system. It can be switched on at any time to quickly stabilize desired behavior.

In an implementation, a system is provided. The system includes a first reservoir computer configured to control a plant displaying nonlinear dynamics, and a second reservoir computer configured to control the first reservoir computer and the plant.

In an implementation, a method is provided. The method includes configuring a first reservoir computer to control a plant displaying nonlinear dynamics, and configuring a second reservoir computer to control the first reservoir computer and the plant.

In an implementation, a method is provided. The method includes controlling a plant using a controller, and controlling the controller and the plant using a reservoir computer.

In an implementation, a method is provided. The method includes controlling a plant using a controller or a first reservoir computer (the first “layer”), controlling the first layer with a reservoir computer (the second layer), controlling the second layer with a reservoir computer, and so on, until specified performance criteria are met.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there is shown in the drawings example constructions of the embodiments; however, the embodiments are not limited to the specific methods and instrumentalities disclosed. In the drawings:

FIG. 1 is block diagram of a generic reservoir computer;

FIG. 2 is a diagram of an implementation of a schematic representation of a controlled plant;

FIG. 3 is a diagram of a schematic representation of an implementation of controlled plant in which the controller comprises multiple reservoirs;

FIG. 4 is an operational flow of an implementation of a method of controlling a dynamical system; and

FIG. 5 shows an exemplary computing environment in which example embodiments and aspects may be implemented.

### DETAILED DESCRIPTION

This description provides examples not intended to limit the scope of the appended claims. The figures generally indicate the features of the examples, where it is understood and appreciated that like reference numerals are used to refer to like elements. Reference in the specification to “one embodiment” or “an embodiment” or “an example embodiment” means that a particular feature, structure, or characteristic described is included in at least one embodiment described herein and does not imply that the feature, structure, or characteristic is present in all embodiments described herein.

Reservoir computing is a technique for training recurrent neural networks (RNNs) that has received much attention in recent years. Compared to deep learning techniques, a reservoir computer (RC) requires significantly less data to achieve good performance and requires much less training time due to the simplicity of the training algorithm. As an RNN, an RC is best suited for time-dependent tasks, and has achieved state-of-the-art performance in time-series prediction, system identification, and spoken-word recognition. Because the bulk of the network is unchanged during the training process, an RC is particularly well-suited to dedicated-purpose artificial neural network (ANN) hardware, including implementations with delayed-optical feedback and electronic Boolean circuits.

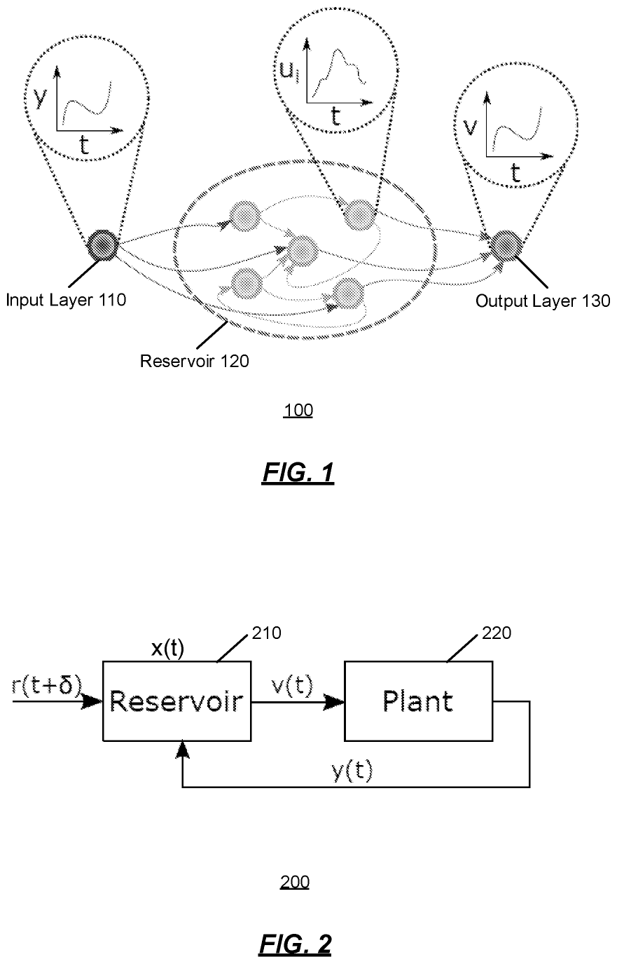

Reservoir computing is characterized by the division of a RNN into 3 parts: an input layer, a recurrent layer known as the reservoir, and an output layer. The division is such that the only recurrent connections in the combined network are contained in the reservoir, leaving in particular only feedforward connections from the reservoir to the output layer. A schematic of this division is in FIG. 1. Each layer may be implemented using a variety of computing devices such as smartphones, desktop computers, laptop computers, tablets, set top boxes, vehicle navigation systems, and video game consoles. Other types of computing devices may be supported. A suitable computing device is illustrated in FIG. 5 as the computing device 500.

FIG. 1 is block diagram of a generic reservoir computer 100. The recurrent neural network is divided into an input layer 110, a recurrent layer known as the reservoir 120, and an output layer 130. The input layer 110 provides random, fixed input weights to the reservoir 120. The reservoir 120 is a large, random, fixed component with random, fixed recurrent connections. Trained (morphable) output weights are provided to the output layer 130.

Input layer 110 to reservoir 120 connections, and reservoir 120 to reservoir 120 connections are initialized to random values and kept fixed during the training process. Only the reservoir 120 to output layer 130 weights are adjusted during training.

To train the network, the input layer 110 to reservoir 120 connection weights Wᵢₙ and the reservoir 120 to reservoir 120 weights W are randomly assigned to initial values and kept fixed during the training process. The network is then driven by an input signal y(t) during a training period. During that period, the response of the reservoir u(t) is observed. Finally, given a desired output signal v_{d}(t), reservoir 120 to output layer 130 weights Wₒᵤₜ are chosen such that the output signal v(t) well approximates v_{d}(t) during the training period, after some initial transient is discarded.

Different implementations of an RC differ by the structure and function of the reservoir. In some implementations, an RC comprising an echo-state network (ESN) is used. The ESN has a reservoir that is a pool of tanh neurons. In continuous-time, the reservoir of an ESN is described by the differential equation

c\dot{u}=−u+tanh(Wu+Wᵢₙy+b),

v=Wₒᵤₜu. (1)

Here, W, Wᵢₙ, and b are the reservoir-reservoir matrix, the input-reservoir matrix, and the bias vector, respectfully. They are the random matrices, i.e., random parameters that are fixed at the initialization of the reservoir and completely describe the reservoir dynamics with respect to an input signal y. The only adjustable parameters are in the reservoir-output matrix Wₒᵤₜ. Wₒᵤₜ is trained.

After driving the ESN and observing the reservoir response, there are a number of ways to identify the output weights Wₒᵤₜ. In some implementations, Tikhonov regularization may be used, as is common in reservoir computing. The procedure is then to choose Wₒᵤₜ that minimizes the loss function given by

$${\sum }_{t = {T}_{init}}^{t = {T}_{train}} {\vert {v}_{d} ( t ) - {W}_{out} u ( t ) \vert}^{2} + β {\vert {W}_{out} \vert}^{2} , \qquad ( 2 )$$

where the sum is taken over a set of measurements of u(t) and v_{d}(t), Tᵢₙᵢₜ is a time chosen to be sufficiently large as to discard the transient response of the reservoir, Tₜᵣₐᵢₙ is the end of the training period, and β is a small parameter chosen to prevent overfitting to data.

Deep reservoir computers are a powerful tool in control engineering, including chaos control, capable of learning a wide range of control laws for completely unknown systems. The techniques described herein can control nonlinear dynamical systems that are not chaotic, as well as nonlinear dynamical systems that are chaotic. A technique is now provided for training a deep reservoir computer for precise, model-free control of dynamical systems, such as a plant, with a deep reservoir computer.

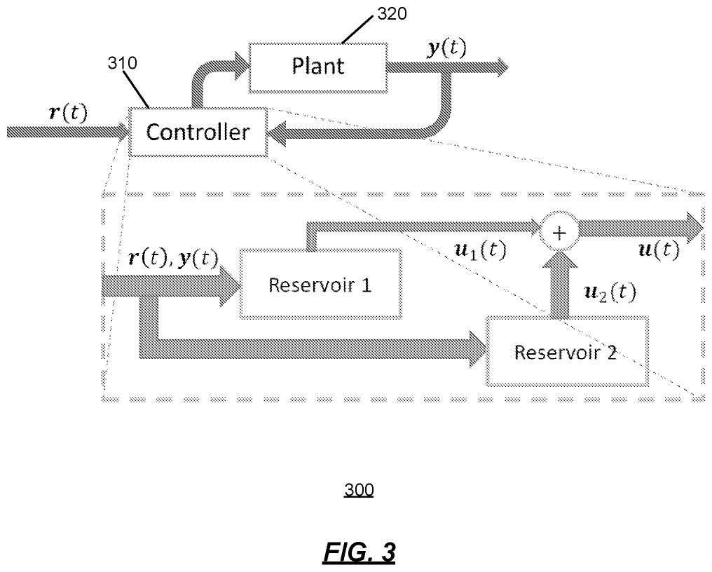

FIG. 2 is a diagram 200 of a schematic representation of an implementation of a controlled plant 220. Measurements of the plant state y(t) and a reference signal r(t+δ) are fed into a reservoir computer referred to as a reservoir 210. The reservoir 210 and the plant 220 may each be implemented using a variety of computing devices such as smartphones, desktop computers, laptop computers, tablets, set top boxes, vehicle navigation systems, and video game consoles. Other types of computing devices may be supported. A suitable computing device is illustrated in FIG. 5 as the computing device 500.

The trained reservoir 210 produces an input signal v(t) that drives the plant 220 such that y(t)→r(t). As described further below, the unknown system (plant) has inputs v, outputs y, and a desired trajectory r. A successful controller produces v such that y→r. The ESN accomplishes this by learning to invert the plant, i.e., by learning to map y(t) and y (t+δ) to v(t). During control, y(t+δ) is replaced with r(t+δ).

The internal state of the plant is described by x, the output of the plant is described by y, and the input (control) to the plant is described by v. Assume the plant is completely described by a state-space-evolution function f and a measurement function g, such that

\dot{x}=f(x,v),

y=g(x). (3)

Note that, if v is constant over an interval from t to t+δ, then f(·, v)=fᵥ(·) may be viewed as a parameterized differential equation. This means that the value of x(t+δ) is determined by initial conditions at t. If v is instead slowly varying from t to t+δ, then it is expected that this equality to instead be an approximation, i.e.,

x(t+δ)=F[x(t),v(t)] (4)

for some function F. This function will not in general be fully invertible, but may be solvable for v(t) on some domain of x(t), x(t+δ).

Under some mild assumptions, ESNs have the ability to synchronize, in a generalized sense, with their inputs. This means that a reservoir is coupled to y(t+δ) and y(t) will tend towards a function the state variables x(t+δ) and x(t), i.e.,

$${lim}_{t -> ∞} u ( t ) = G [ x ( t + δ ) , x ( t ) ] . \qquad ( 5 )$$

Therefore choose Tᵢₙᵢₜ in the RC algorithm such that this limit approximately holds.

If v_{d} is chosen to be the input to the plant v in Eq. 4, then output weights Wₒᵤₜ are being chosen such that:

v(t)=WₒᵤₜG[x(t+δ),x(t)]≈F⁻¹[x(t+δ),x(t)]. (6)

It is this sense in which the reservoir is being trained to “invert” the plant dynamics.

The training data is acquired by perturbing the plant with some random, exploratory inputs vₜᵣₐᵢₙ from t=0 to t=Tₜᵣₐᵢₙ+δ. During that time, triplets y(t+δ), y(t), and vₜᵣₐᵢₙ(t) are collected and used to train an ESN above.

After the reservoir is trained, replace y(t+δ) with r(t+δ), where r(t) is a reference signal that describes the desired behavior of the plant. The output of the reservoir is used as the new input to the plant. The complete dynamics of the controlled plant are then described by

\dot{x}=f(x,v),

y=g(x),

c\dot{u}=−u+tanh(Wu+Wᵢₙ^{y}y+Wᵢₙ^{r}r_{δ}+b),

v=Wₒᵤₜu. (7)

For notational convenience, write r(t+δ)=r_{δ} and split the input weights into W^{y}ᵢₙ and W^{r}ᵢₙ, the latter of which couples to y(t+δ) in the training phase and r(t+δ) in the control phase. A schematic of this controlled plant configuration is in FIG. 2.

In some implementations, a Lorenz chaotic dynamical system may be controlled to a wide variety of possible behavior, such as stabilizing unstable steady states, unstable periodic orbits, and periodic orbits not on the Lorenz attractor. Eq. 7 together with the prescribed training algorithm is capable of controlling the Lorenz system for a number of different r(t). However, the error between y(t) and r(t) does not converge to 0, because the reservoir only approximately learns the inverse of plant dynamics. Further, increasing the size of the reservoir appears to hit a hard wall, beyond which the error in the training signal continues to decrease, but error to the reference signal does not.

To overcome this hard wall, observe that Eq. 7 describes another (partially) unknown dynamical system to control. Due to coupling to the first controller, the attractor of y is closer to the attractor of the reference signal r. Drive the dynamics of the controlled plant with v+v₁, where v₁ is the output of a second reservoir. By repeating the training process with the new reservoir, augment the controlled plant in Eq. 7 and bring the attractor of the plant closer to that of the reference signal. Controllers can be added to reduce the target error. The resulting controlled plant can be thought of as a deep ESN, where the layers of the reservoir learn to control the plant on attractors that are iteratively closer to a reference attractor.

The techniques may be applied to the control of a chaotic plant to a wide variety of target behaviors, for example, a Lorenz system. Lorenz is a paradigmatic example of chaos and displays sufficiently complex behavior to demonstrate the range of control made possible by the techniques described herein. Note that similar results hold for many other systems, including the Chua circuit, the Mackey-Glass system, the Duffing oscillator, and high dimensional nonlinear and linear systems.

The autonomous Lorenz system is described by the differential equations

\dot{x}₁=σ(x₁−x₂),

\dot{x}₂=x₁(ρ−x₃)−x₂,

\dot{x}₃=x₂x₂−βx₃. (8)

Consider typical parameters σ=10, ρ=28, and β=8/3, for which Eq. 1 displays chaotic behavior. Unstable steady states (USSs) exist at (x₁, x₂, x₃)=(0, 0, 0) and (x₁, x₂, x₃)=(ρ, ±√(ρβ), ±√(ρβ)). The origin is difficult to control due to the odd number of real eigenvalues in the Jacobian.

Choose the plant to be a multiple-input-multiple-output (MIMO) version of Lorenz. This means that the complete state is able to be measured by a controller, and that the controller can exert effort on the dynamics of each state variable. Thus, the complete plant dynamics are described by

\dot{x}₁=σ(x₁−x₂)+u₁,

\dot{x}₂=x₁(ρ−x₃)−x₂+u₂,

\dot{x}₃=x₂x₂−βx₃+u₃,

y₁=x₁,

y₂=x₂,

y₃=x₃. (9)

A deep reservoir computer, trained according to the techniques described above, is capable of inducing a wide variety of behavior in Eq. 2. In particular, USSs and unstable periodic orbits (UPOs) are stabilized. A motion is forced near but away from the attractor of Eq. 1. A predicting reservoir is used to force synchronization of Eq. 2 to an autonomous Lorenz target system.

Thus, in some implementations, a technique is provided for control of a nonlinear dynamical system to an arbitrary trajectory. The technique does not require any knowledge of the dynamical system, and thus is completely model-free. When applied to a chaotic system, it is capable of stabilizing unstable periodic orbits (UPOs) and unstable steady states (USSs), controlling orbits that require non-vanishing control signal, synchronization to other chaotic systems, and so on. It is based on a type of recurrent neural network (RNN) known as a reservoir computer (RC), which, as shown, is capable of directly learning how to control an unknown system. In an embodiment, precise control to a desired trajectory is obtained by iteratively adding layers to the controller, forming a deep recurrent neural network

In an implementation, a system comprises a first reservoir computer configured to control a plant, and a second reservoir computer configured to control the first reservoir computer and the plant. In some implementations, each of the first reservoir computer and the second reservoir comprises a recurrent neural network. A deep reservoir computer may comprise the first reservoir computer and the second reservoir computer, wherein the deep reservoir computer is configured to provide precise, model-free control of the plant. The first reservoir computer and the plant comprise a first layer, and the second reservoir computer is configured to train the first layer. Moreover, the second reservoir computer and the first layer may comprise a second layer, and a third reservoir computer may be configured to train the second layer. According to some aspects, the first layer and the second layer form a deep recurrent neural network.

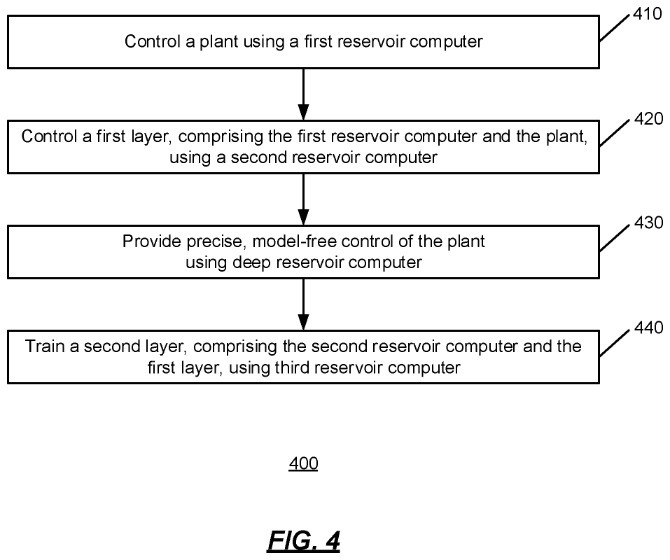

More particularly, with respect to deep control, better accuracy is obtained by training a second reservoir to control the plant and the first reservoir. FIG. 3 is a diagram 300 of a schematic representation of an implementation of controlled plant 320 in which the controller 310 comprises multiple reservoirs, in this example reservoir 1 and reservoir 2. In this manner, a second reservoir (reservoir 2) is trained to control the system that comprises the plant 320 and the first reservoir (reservoir 1). The reservoirs 1 and 2, the controller 310, and the plant 320 may each be implemented using a variety of computing devices such as smartphones, desktop computers, laptop computers, tablets, set top boxes, vehicle navigation systems, and video game consoles. Other types of computing devices may be supported. A suitable computing device is illustrated in FIG. 5 as the computing device 500.

The controlled system (the plant 320+the reservoir 1) is viewed as a new system to be controlled (i.e., a new dynamical system). It is no longer chaotic. The second reservoir (reservoir 2) learns the inverse of the controlled system and improves target error by several orders of magnitude.

Here, the process described above with respect to FIG. 2 can be repeated n times, resulting in an n-layer ESN controller. Accuracy improves with each layer. Adding additional layers is only a linear increase in complexity, because the control algorithm is being repeated for each additional layer. It has been determined that adding a second reservoir brings the Lorenz system much closer to a true fixed point. Further additional reservoirs bring the Lorenz system even closer to a true fixed point. Thus, stacking reservoirs is a highly effective strategy for precise control of unknown dynamical systems. The technique works well with MIMO systems, including chaotic systems such as Lorenz and high dimensional linear systems. The technique can improve asymptotic target error by several orders of magnitude with only a linear increase in nodes and training time.

Thus, reservoir computers can learn the inverse dynamics of a nonlinear system. The reservoir computer can be used to control complex dynamics of chaotic systems for states embedded with the attractor or for nearby orbits. A layered (i.e., deep) reservoir computer architecture provides greatly improved control. The layered structure allows learning the dynamics about the desired state which is used to provide the greatly improved control.

In some implementations, the plant may be first controlled with a standard controller, such as a linear proportional-integral-derivative controller (PID controller). The standard controller is able to provide some control of a nonlinear dynamical system. The plant and the standard controller may be considered as a new plant, and a reservoir computer controller is provided to control this new plant. Additional reservoir computer layers may be subsequently added. In this manner, in some implementations, the first layer is a standard controller.

In some implementations, the plant may be first controlled with a custom model-based controller. The model-based controller is based on a non-linear mathematical description of the plant that may be derived from theory and experimental measurements. The model-based controller, as above, provides some control of a nonlinear dynamical system, but typically the model may not match the actual plant through, e.g. unmodelled and/or unknown physics, manufacturing variances in the plant, etc. These differences may become important in some types of plants and operating conditions, especially in the case of chaos. As above, the plant and the standard controller may be considered as a new plant, and a reservoir computer controller is provided to control this new plant. Additional reservoir computer layers may be subsequently added. In this manner, in some implementations, the first layer is a standard controller.

In an embodiment, a method for learning control laws for unknown dynamical systems is provided. It is based on a type of neural network known as a reservoir computer and techniques and algorithms for training several such networks arranged in a deep architecture. This method has advantages over conventional control approaches, including: (1) it requires no knowledge at all about the system to be controlled, (2) it can be trained more quickly and with less data than deep feedforward networks, (3) very precise control can be achieved with a relatively small network, and (4) it can be implemented with fast, dedicated hardware approaches, such as FPGA-based reservoir computers.

Because layers of the controller are learned iteratively, new layers can be added when small changes in the dynamical system occur due to damage or changing conditions. It is thus well-suited for applications such as control of aircraft, automated manufacturing, and robotics.

As noted above, the techniques described herein can control nonlinear dynamical systems that are not chaotic, as well as nonlinear dynamical systems that are chaotic. A drone is an example of a nonlinear dynamical system that is not chaotic that can be controlled by the techniques described herein. An autonomous vehicle is another example of a nonlinear dynamical system that is not chaotic that can be controlled by the techniques described herein.

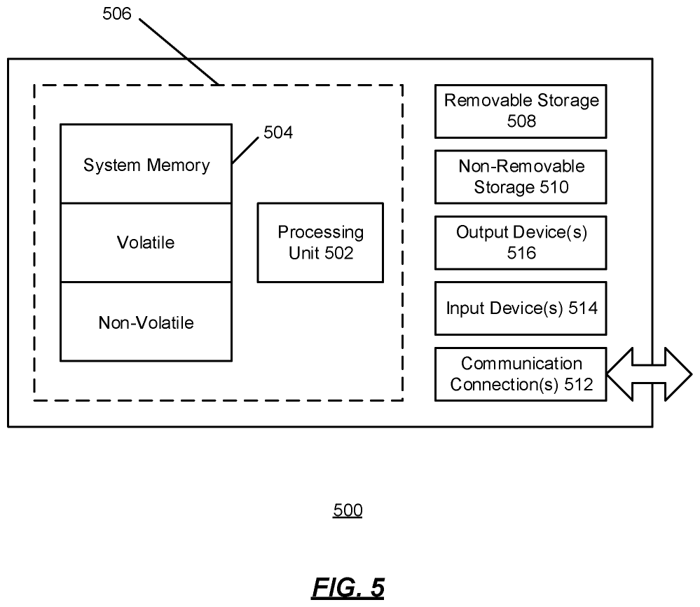

FIG. 4 is an operational flow of an implementation of a method 400 of controlling a dynamical system. The method 400 may be implemented using one or more computing devices, such as the computing device illustrated in FIG. 5.

At 410, a plant is controlled by a first reservoir computer configured to control a plant. At 420, a second reservoir computer controls the first reservoir computer and the plant. Each of the first reservoir computer and the second reservoir comprises a recurrent neural network. In some implementations, the first reservoir computer and the plant comprise a first layer, and the second reservoir computer is configured to train the first layer.

At 430, a deep reservoir computer provides precise, model-free control of the plant. The deep reservoir computer comprises the first reservoir computer and the second reservoir computer.

At 440, a third reservoir computer trains a second layer that comprises the second reservoir computer and the first layer. In some implementations, the first layer and the second layer form a deep recurrent neural network.

FIG. 5 shows an exemplary computing environment in which example embodiments and aspects may be implemented. The computing device environment is only one example of a suitable computing environment and is not intended to suggest any limitation as to the scope of use or functionality.

Numerous other general purpose or special purpose computing devices environments or configurations may be used. Examples of well known computing devices, environments, and/or configurations that may be suitable for use include, but are not limited to, personal computers, server computers, handheld or laptop devices, multiprocessor systems, microprocessor-based systems, network personal computers (PCs), minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 5, an exemplary system for implementing aspects described herein includes a computing device, such as computing device 500. In its most basic configuration, computing device 500 typically includes at least one processing unit 502 and memory 504. Depending on the exact configuration and type of computing device, memory 504 may be volatile (such as random access memory (RAM)), non-volatile (such as read-only memory (ROM), flash memory, etc.), or some combination of the two. This most basic configuration is illustrated in FIG. 5 by dashed line 506.

Computing device 500 may have additional features/functionality. For example, computing device 500 may include additional storage (removable and/or non-removable) including, but not limited to, magnetic or optical disks or tape. Such additional storage is illustrated in FIG. 5 by removable storage 508 and non-removable storage 510.

Computing device 500 typically includes a variety of computer readable media. Computer readable media can be any available media that can be accessed by the device 500 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 504, removable storage 508, and non-removable storage 510 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 500. Any such computer storage media may be part of computing device 500.

Computing device 500 may contain communication connection(s) 512 that allow the device to communicate with other devices. Computing device 500 may also have input device(s) 514 such as a keyboard, mouse, pen, voice input device, touch input device, etc. Output device(s) 516 such as a display, speakers, printer, etc. may also be included. All these devices are well known in the art and need not be discussed at length here.

In an implementation, a system is provided. The system includes a first reservoir computer configured to control a plant displaying nonlinear dynamics, and a second reservoir computer configured to control the first reservoir computer and the plant.

Implementations may include some or all of the following features. Each of the first reservoir computer and the second reservoir comprises a recurrent neural network. The system further comprises a deep reservoir computer that comprises the first reservoir computer and the second reservoir computer, wherein the deep reservoir computer is configured to provide precise, model-free control of the plant. The first reservoir computer and the plant comprise a first layer, and the second reservoir computer is configured to train the first layer. The second reservoir computer and the first layer comprise a second layer, and the system further comprises a third reservoir computer configured to train the second layer. The first layer and the second layer form a deep recurrent neural network. The first reservoir computer and the second reservoir computer are comprised within an n-layer echo-state network (ESN) controller, or wherein each of the reservoir computers in the n-layer controller comprises a physical system. Each of the first reservoir computer and the second reservoir computer comprises a physical system, such as an autonomous logic circuit or an optoelectronic system.

In an implementation, a method is provided. The method includes configuring a first reservoir computer to control a plant, and configuring a second reservoir computer to control the first reservoir computer and the plant.

Implementations may include some or all of the following features. Each of the first reservoir computer and the second reservoir comprises a recurrent neural network. The method further comprises configuring a deep reservoir computer to provide precise, model-free control of the plant, wherein the deep reservoir computer comprises the first reservoir computer and the second reservoir computer. The first reservoir computer and the plant comprise a first layer, and the method further comprises configuring the second reservoir computer to train the first layer. The second reservoir computer and the first layer comprise a second layer, and the method further comprises configuring a third reservoir computer to train the second layer. The first layer and the second layer form a deep recurrent neural network.

In an implementation, a method is provided. The method includes controlling a plant using controller, and controlling the controller and the plant using a reservoir computer.

Implementations may include some or all of the following features. The controller comprises a linear proportional-integral-derivative controller (PID controller), a standard non-linear controller, or a custom model-based controller. The method further comprises providing precise, model-free control of the plant using a deep reservoir computer. The controller and the plant comprise a first layer, and the method further comprises training the first layer using the reservoir computer. The reservoir computer and the first layer comprise a second layer, and the method further comprises training the second layer using an additional reservoir computer. The method further comprises forming a deep recurrent neural network using the first layer and the second layer.

It should be understood that the various techniques described herein may be implemented in connection with hardware components or software components or, where appropriate, with a combination of both. Illustrative types of hardware components that can be used include Field-Programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. The methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices might include personal computers, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A system comprising:
a first reservoir computer configured to control a plant displaying nonlinear dynamics; and
a second reservoir computer configured to control the first reservoir computer and the plant.

2. The system of claim 1, wherein each of the first reservoir computer and the second reservoir comprises a recurrent neural network.

3. The system of claim 1, further comprising a deep reservoir computer that comprises the first reservoir computer and the second reservoir computer, wherein the deep reservoir computer is configured to provide precise, model-free control of the plant.

4. The system of claim 1, wherein the first reservoir computer and the plant comprise a first layer, and the second reservoir computer is configured to train the first layer.

5. The system of claim 4, wherein the second reservoir computer and the first layer comprise a second layer, and further comprising a third reservoir computer configured to train the second layer.

6. The system of claim 5, wherein the first layer and the second layer form a deep recurrent neural network.

7. The system of claim 1, wherein the first reservoir computer and the second reservoir computer are comprised within an n-layer echo-state network (ESN) controller, or wherein each of the reservoir computers in the n-layer controller comprises a physical system.

8. The system of claim 1, wherein each of the first reservoir computer and the second reservoir computer comprises a physical system, such as an autonomous logic circuit or an optoelectronic system.

9. A method comprising:
configuring a first reservoir computer to control a plant; and
configuring a second reservoir computer to control the first reservoir computer and the plant.

10. The method of claim 9, wherein each of the first reservoir computer and the second reservoir comprises a recurrent neural network.

11. The method of claim 9, further comprising configuring a deep reservoir computer to provide precise, model-free control of the plant, wherein the deep reservoir computer comprises the first reservoir computer and the second reservoir computer.

12. The method of claim 9, wherein the first reservoir computer and the plant comprise a first layer, further comprising configuring the second reservoir computer to train the first layer.

13. The method of claim 12, wherein the second reservoir computer and the first layer comprise a second layer, further comprising configuring a third reservoir computer to train the second layer.

14. The method of claim 13, wherein the first layer and the second layer form a deep recurrent neural network.

15. A method comprising:
controlling a plant using a controller; and
controlling the controller and the plant using a reservoir computer.

16. The method of claim 15, wherein the controller comprises a linear proportional-integral-derivative controller (PID controller).

17. The method of claim 15, wherein the controller is a custom, model-based non-linear controller.

18. The method of claim 15, wherein the controller and the plant comprise a first layer, further comprising training the first layer using the reservoir computer.

19. The method of claim 18, wherein the reservoir computer and the first layer comprise a second layer, further comprising training the second layer using an additional reservoir computer.

20. The method of claim 19, further comprising forming a deep recurrent neural network using the first layer and the second layer.
